(19) United States
(12) Patent Application Publication
(10) Pub. No.: US 2007/0278721 A1
(43) Pub. Date: Dec. 6, 2007

(54) Extrusion blow molding method for plastic barrels

(76) Inventor: Harald Feuerherm, Troisdorf (DE)

Correspondence Address: WILLIAM COLLARD;COLLARD & ROE, P.C., 1077 NORTHERN BOULEVARD, ROSLYN, NY, 11576, US

(21) Appl. No.: 11/726,224

(22) Filed: Mar. 21, 2007

(30) Foreign Application Priority Data
Mar. 21, 2006 (DE) 10 2006 013 302.1

(51) Int. Cl. B29C 49/04; B29C 47/22

(52) U.S. Cl. 264/531; 700/303

(57) ABSTRACT

A method for the extrusion of preforms (1), which exit from a die gap of an extrusion head (4) delimited by a mandrel (2) and a die ring (3), and are widened in a blow mold (5). The width of the die gap is changed during the extrusion of the preforms, by means of a setting movement of the mandrel and/or of the die ring. The cross-sectional geometry of an elastically deformable sleeve (9) disposed on the extrusion head (4) and delimiting the die gap on the circumference side is also changed during the extrusion of the preforms. By means of setting movements of an additional element (10) that is controlled or regulated separately, the melt distribution on the circumference side is changed at least in that section of the preforms (1) that is widened to form an upper barrel end in the blow mold (5). In this connection, the deformation of the sleeve (9) and the setting movements of the additional element (10) are coordinated with one another in such a manner that the upper region of the barrels widened in the blow mold has no deviations in thickness from default values in the circumference direction.

Applicant claims priority under 35 U.S.C. §119 of German Application No. DE 10 2006 013 302.1 filed Mar. 21, 2006.

### BACKGROUND OF THE INVENTION

The invention relates to a method for the extrusion of tubular preforms that exit from a die gap of an extrusion head delimited by a mandrel and a die ring, and are widened in a blow mold to produce plastic barrels having a round cross-section and a collar which is formed by upsetting. Using the method, it is supposed to be possible to produce open barrels that can be closed off with a lid, tap barrels, and, in particular, also swage-bond barrels, which have a collar that is approximately L-shaped in cross-section and runs around the circumference, in their head region and/or bottom region. Such barrels are also called L-ring barrels.

An extrusion blow molding method for the production of plastic barrels is known from WO 99/44805. Tubular preforms, which consist of a plastic melt, exit from the ring-shaped die gap of an extrusion head, and are widened into the finished products in a blow mold disposed below the extrusion head. During the extrusion of the preforms, the die gap width is changed by means of program-controlled setting movements of a mandrel or die ring. To control the die gap width, the wall thickness of the tubular preform is adjusted to be thinner towards the bottom and thicker towards the top, towards the extrusion head. In this way, one compensates for the fact that the preform becomes longer, due to its own weight, until it is placed into the blow mold. At the upper and lower end of the preforms, the preform sections, which are offset by 90° relative to the parting plane of the blow mold halves, are subject to significantly greater stretching in the blow mold than the regions that lie in the parting plane. The wall sections of the preforms that are exposed to greater stretching in the blow mold are reinforced with thick spots during extrusion of the preforms, and have a correspondingly greater wall thickness. In order to produce thin spots and thick spots in the preforms, die slide valves that partially change the width of the die gap in the circumference direction are used, within the framework of known measures. However, the die slide valves have the disadvantage that the die gap geometry can be designed only for a certain section of the preforms. Only in this section can the die slide valves bring about an optimal melt distribution in the circumference direction. In addition, there is the problem that in the case of production changes, for example in the case of a change in container weight or the use of a different plastic, the die slide valves must be exchanged and replaced with die slide valves having a different profile. This is very complicated.

It is known to use a flexibly deformable ring in place of a die slide valve, in order to influence the melt distribution of the preforms exiting from the extrusion head of a blow molding system in the circumference direction (Plastverarbeiter 32 (1981), No. 3, pages 326 to 330). The elastically deformable sleeve consists of a metal ring having a thin wall, which is disposed on the extrusion head on the mandrel or die ring side, and delimits the die gap on the circumference side. By means of at least two force drives that lie opposite one another, which act on the circumference of the sleeve, the cross-sectional geometry of the ring is changed and the die gap width is influenced in the circumference direction. When using a deformable ring, the die gap geometry during the preform extrusion can be regulated in such a manner that the hollow body that exits from the blow mold has an approximately uniform wall thickness in all cross-sectional planes, which corresponds to the default values. In the production of barrels, particularly L-ring barrels, it has been shown, however, that slight wall thickness differences in the circumference direction can still occur, due to the system, which are attributable to the fact that the elastically deformable ring has deformation-neutral regions, if the ring is transferred to an oval shape by means of two force drives that lie opposite one another. These deformation-neutral regions are oriented at approximately 45° relative to the deformation axis. In this regard, the invention is aiming at a further improvement.

An extrusion blow molding method is known from EP 0 945 245 A1, with which hollow bodies that have a cross-section that deviates from the circular shape and have a predetermined wall thickness can be produced. In the extrusion of the preforms, the melt distribution is changed in the circumference direction by means of an elastically deformable sleeve disposed in the extrusion head, which delimits the die gap on the circumference side, and additionally influenced by means of setting movements of an additional element that is controlled separately. The additional element reinforces the profiling of the preform in desired regions. The reinforcement of the profiling is utilized to produce hollow bodies having a cross-section that deviates from the circular shape. By means of the additional element, one achieves the result that the elastic sleeve does not have to be deformed too greatly, which extends the useful lifetime of the elastically deformable sleeve. The problem of making the wall thickness distribution at the upper end of blow-molded barrels uniform is not solved by the method.

An extrusion blow molding method is described in EP 0 885 711 B1, in which the cross-sectional geometry of an elastically deformable sleeve disposed in the extrusion head and delimiting the die gap on the circumference side is changed during the extrusion of the preforms. The elastically deformable sleeve and the force drives assigned to it are disposed in a support ring that is disposed to be radially movable in the die housing, and can be radially adjusted by means of a controllable additional force drive. Using the method, preforms having non-symmetrical melt distributions in the circumference direction can be produced, which are widened in a subsequent blow mold, to produce hollow bodies having a complicated shape. In particular, the method is suitable for the production of preforms that are shaped into plastic containers. The known arrangement is not suitable for extrusion blow molding of barrels that have rotation symmetry with regard to their longitudinal axis.

### SUMMARY OF THE INVENTION

In front of this background, the invention is based on the task of indicating an extrusion blow molding method for plastic barrels, which assures that the blow mold bodies have a predetermined wall thickness over their entire length, including their critical head region and bottom region, which does not deviate from default values in the circumference direction. The method is particularly supposed to be suitable for the production of swage-bond barrels, which have a collar that is L-shaped in cross-section, in the head region and/or the bottom region.

The object of the invention and the solution for this task is a method for the extrusion of tubular preforms that exit from a die gap of an extrusion head delimited by a mandrel and a die ring, and are widened in a blow mold to produce plastic barrels having a round cross-section and a collar which is formed by upsetting,
whereby the die gap width is changed during the extrusion of the preforms, by means of a setting movement of the mandrel and/or of the die ring,
whereby the cross-sectional geometry of an elastically deformable sleeve delimiting the die gap on the circumference side is changed during the extrusion of the preforms,
whereby the circumference-side melt distribution is influenced, at least in the sections of the preforms that are widened in the blow mold to form an upper barrel end and a barrel bottom, by means of setting movements of at least one additional element that is controlled separately, and
whereby the deformation of the sleeve and the setting movements of the additional element are coordinated with one another in such a manner that the upper end of the barrels widened in the blow mold and the transition region of the barrels between barrel bottom and barrel mantle, in the circumference direction, do not have any thickness deviations from default values.

The invention starts from the recognition that an elastic ring has deformation-neutral regions, which are not deformed or only deformed slightly during deformation of the ring into an oval cross-sectional geometry. These regions are oriented essentially at 45° relative to the main deformation axis. By means of the use of a separately controlled additional element, according to the invention, the melt distribution of the preforms, on the circumference side, can be adjusted with a greater degree of freedom, particularly in these regions. The deformation of the sleeve and the setting movements of the additional element are coordinated, according to the invention, in such a manner that the upper end of the barrels widened in the blow mold and the transition region of the barrels between barrel bottom and barrel mantle, in the circumference direction, do not have any thickness deviation from default values. Upper end means, in particular, the head region of an open barrel, having a peripheral collar which is formed by upsetting or the head of a tap barrel, or of an L-ring barrel, all barrels having a collar which is formed by upsetting. By means of the method according to the invention, it is possible to produce the collar, in particular, as well as the transition region that follows the collar at the bottom and at the top, in the circumference direction, with a defined wall thickness that corresponds to default values.

The elastic sleeve that can be disposed in the flow channel on the mandrel side or on the die ring side is brought into an essentially cylindrical shape in accordance with a control program that runs with the preform extrusion, when a center section of the preforms is extruded. By means of deformation of the sleeve, an oval cross-sectional shape of the sleeve is set when the beginning and end sections of the preforms are extruded, which are widened in the blow mold to form a barrel bottom and an upper barrel end. By means of additional program-controlled setting movements of the additional element, the melt profile of the preforms is corrected in the beginning and end sections, in order to even out partial thickness differences in the circumference direction in the head region and bottom region of the blow-molded barrels.

Another advantageous embodiment of the method according to the invention provides that the elastically deformable sleeve is deformed during the preform extrusion by means of two force drives that lie opposite one another, the setting movements of which exert tensile and/or pressure forces on the sleeve in a deformation axis oriented radially towards the center axis of the mandrel, and that the additional element acts on sections of the die gap to which deformation-neutral regions of the elastically deformable sleeve are assigned, which regions are only slightly deformable under the effect of the force drives. In the case of a mandrel-side arrangement, the elastically deformable sleeve is preferably deformed, during preform extrusion, by means of a vertically oriented force drive that is connected with the sleeve with actuating means that are oriented essentially radially. Here again, the additional element acts on sections of the die gap to which deformation-neutral regions of the elastically deformable sleeve are assigned, which regions are only slightly deformable under the effect of the force drive.

Further elastically deformable sleeves can be used as an additional element, which sleeves delimit the die gap on the circumference side and are deformed, during the extrusion of beginning and end sections of the preforms, by means of activation of setting drives that act on the sleeve. The direction of effect of the setting drives is oriented at an angle, preferably an angle of 45°, relative to the deformation axis of the first elastically deformable sleeve. However, slide valves that can be adjusted horizontally or vertically are also suitable as setting elements; the gap width of the die gap, in the circumference direction, is partially changed by their setting movements.

The deformable sleeve and the program-controlled additional element can be disposed essentially at the same height on sections of the mandrel and of the die ring that lie opposite one another. It also lies within the scope of the invention to dispose the deformable sleeve and the program-controlled additional element one behind the other, in the melt flow direction. The sleeve and the additional element can optionally be disposed on the mandrel side or on the die ring side.

It is practical if the setting movements of the additional element are controlled by a program that runs at the same time as a wall thickness program, which controls the setting movements of the mandrel and/or of the die ring as well as the force drives that act on the elastic sleeve. In addition, there is the possibility of controlling the setting movements of the additional element as a function of time, as a function of path, or as a function of the tube length of the preforms exiting from the die gap. It is understood that all of the controls can also be provided with regulation circuits that check the setting paths of the additional elements and of the force drives that act on the deformable sleeve, and assure that these paths are adhered to, in accordance with the defaults of the program.

An alternative embodiment of the method according to the invention comprises the following method steps:
The gap width is changed during the extrusion of the preforms, by means of a setting movement of the mandrel and/or of the die ring;
the cross-sectional geometry of an elastically deformable sleeve delimiting the die gap on the circumference side is changed by means of controlled setting movements of two first setting devices disposed diametrically opposite one another, during the extrusion of the preforms;
the cross-sectional geometry of the sleeve is changed by means of setting movements of a group of second setting devices that are controlled separately and disposed radially offset from the first setting devices, and also act on the elastic sleeve, in order to correct the melt distribution in end sections of the preforms, which is widened in the blow mold to form an upper barrel end or to form a bottom;
the setting movement of the second setting devices that are added is coordinated with the setting movement of the first setting devices in such a manner that the upper end of the barrels widened in the blow mold, and the transition region of the barrels between the barrel bottom and barrel mantle, in the circumference direction, do not have any thickness deviations from default values.

Preferably, force drives are used as first setting devices, which are connected with the elastic sleeve in fixed manner in terms of tension and pressure. Tappets that can be moved against the elastic sleeve with radial setting movements can be used as second setting devices. However, force drives can also be used, which are connected with the sleeve in fixed manner in terms of tension and pressure. Preferably, the group of the first setting devices and the group of the second setting devices are oriented in such a manner that the force effect direction of the first setting devices and the force effect direction of the second setting devices are oriented at a right angle relative to one another.

The elastic sleeve is brought into a cylinder shape having an essentially circular cross-section, in accordance with a control program that runs with the preform extrusion, when a center section of the preforms is extruded. By means of deformation of the sleeve, an oval cross-sectional shape of the sleeve is set when the beginning and end sections of the preforms are extruded, which are widened in the blow mold to form a barrel bottom and an upper barrel end. By means of additional program-controlled setting movements of the second setting devices, the melt profile of the preforms can finally still be corrected in the beginning and end sections, in order to even out partial thickness differences in the circumference direction in the head region and bottom region of the blow-molded barrels. The group of the second setting devices can be controlled by a program that runs at the same time as a wall thickness program, which controls the setting movements of the mandrel and/or of the die ring, as well as of the first setting devices that act on the elastic sleeve. In addition, there is also the possibility of controlling the setting movements of the second setting devices as a function of time, as a function of path, or as a function of the tube length of the preforms exiting from the die gap. All of the controls can also be provided with regulation circuits that check the setting paths of the first and second setting devices and assure that these paths are adhered to, in accordance with the defaults of the program.

### BRIEF DESCRIPTION OF THE DRAWINGS

In the following, the invention will be described in greater detail, using a drawing that shows an embodiment merely as an example. This shows, schematically:

FIG. 1 in longitudinal section, a greatly simplified representation of a system for the extrusion of preforms, which are widened into barrels in a blow mold,

FIG. 2 a program control for the system shown in FIG. 1,

FIG. 3 the melt distribution in the preforms in different sectional planes,

FIG. 4 a method product produced using the system shown in FIG. 1,

FIG. 5 and 6 design embodiments of the device used in the system, in longitudinal section, in each instance,

FIG. 7 another design embodiment of the device, in horizontal section,

FIG. 8 another design embodiment of the device, in longetudinal section.

### DETAILED DESCRIPTION OF THE EMBODIMENTS

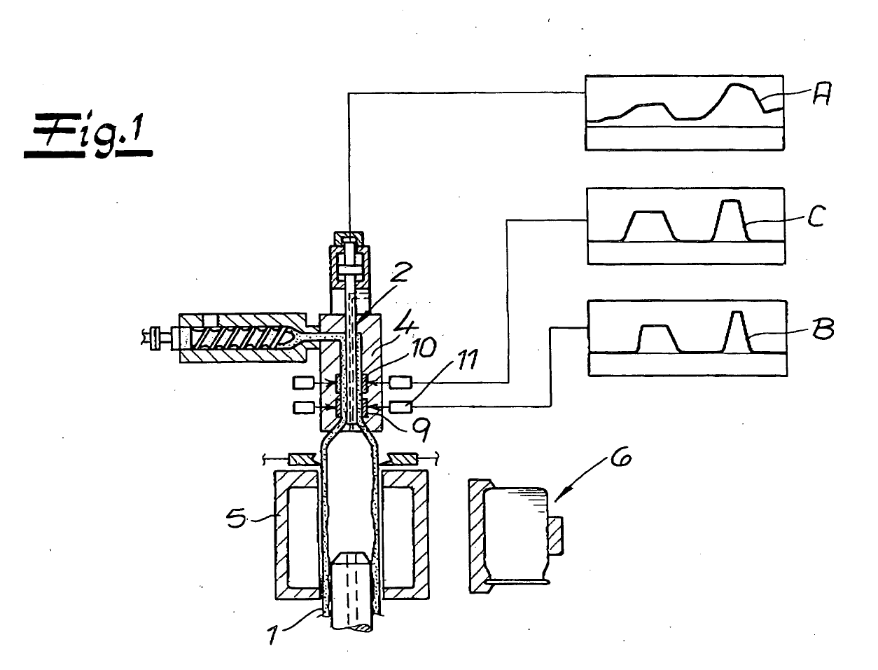

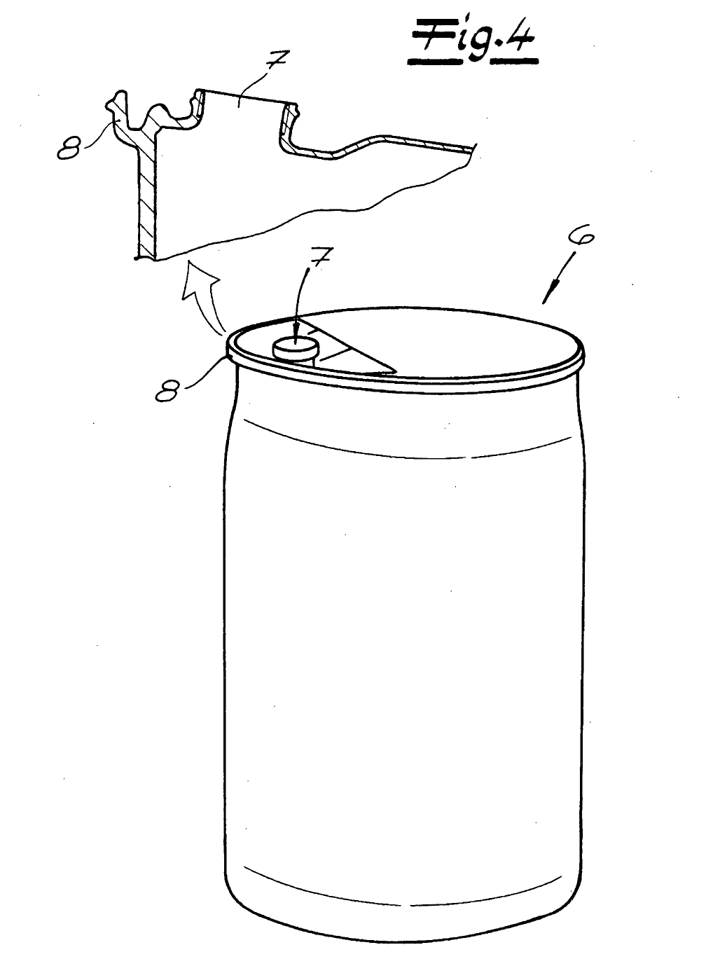

FIG. 1 shows a method for the extrusion of tubular preforms 1 that exit from a die gap of an extrusion head 4 delimited by a mandrel 2 and a die ring 3, and are widened in a blow mold 5 to produce barrels 6 having a round cross-section. In particular, swage-bond barrels can be produced using the method, which are provided with a tap opening 7 at their upper end and have a collar 8 that is L-shaped in cross-section at their outer circumference (FIG. 4). Such barrels are also called L-ring barrels. The proper formation of the collar 8 as well as of the transition region that follows the collar at the top and at the bottom is a deciding factor for the usage properties. The collar as well as the bottom and top transition region form a region that is critical for the usage properties of the barrel. Here, only slight deviations in thickness from default values are acceptable in the circumference direction. Deviations have a particularly disadvantageous effect in the case of a drop test of the barrels. Furthermore, a uniform wall thickness in the bottom region is important. Thickness deviations in the circumference direction in the transition region of the barrels between barrel bottom and barrel mantle have a detrimental effect on the swage value, i.e. the stacking strength of the barrels.

The tubular preforms exit from the ring-shaped die gap of the extrusion head 4 in the thermoplasticized state. The width of the die gap is changed, during the extrusion of the preforms, by means of a setting movement of the mandrel 2 and/or of the die ring 3. Furthermore, the cross-sectional geometry of an elastically deformable sleeve 9 disposed in the extrusion head and delimiting the die gap on the circumference side is changed during the extrusion of the preforms 1. The sleeve 9 consists of metal, for example, and has a thin wall. It could also consist of two or more layers. The sleeve can be disposed in the flow channel on the mandrel side or on the die ring side. In addition, the melt distribution on the circumference side is changed, at least in the sections of the preforms that is widened in the blow mold 5 to form an upper barrel end and the lower barrel radius, by means of setting movements of a separately controlled or regulated additional element 10. In the exemplary embodiment, barrel end means the head region of the barrels, if applicable with one or more tap openings, and a ring-shaped collar. The deformation of the sleeve 9 and the setting movements of the additional element 10 are coordinated with one another in such a manner that the upper end of the barrels 6 widened in the blow mold and the transition region of the barrels between barrel bottom and barrel mantle have no thickness deviations from default values in the circumference direction.

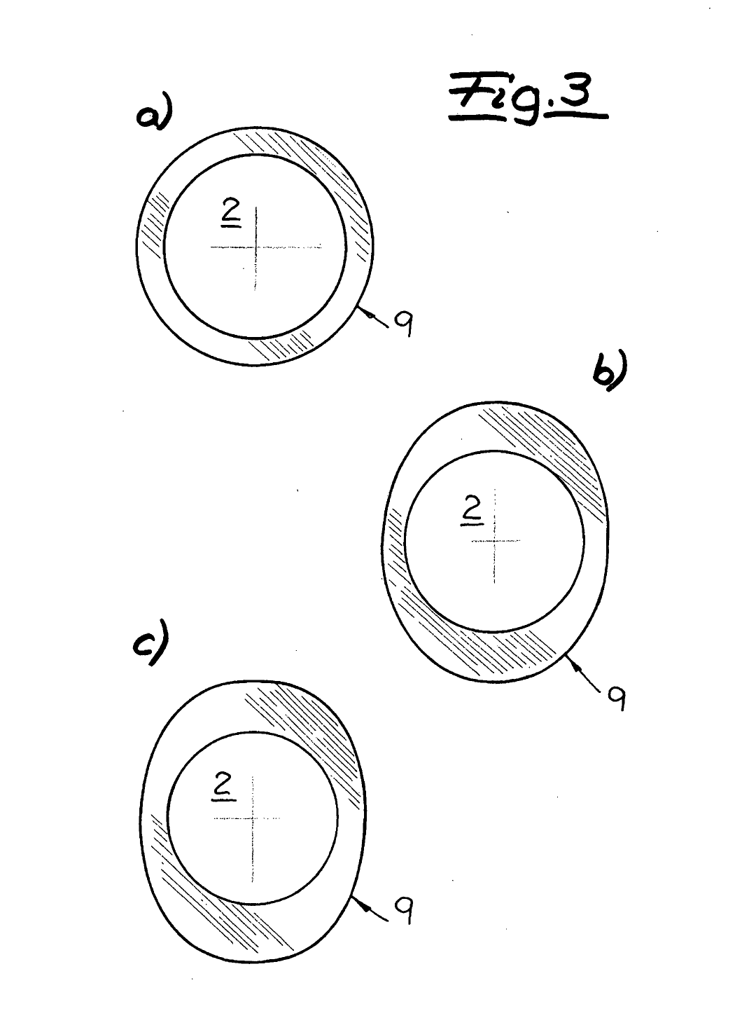

The elastic sleeve 9 is brought into an essentially cylindrical shape in accordance with a control program that runs with the preform extrusion, when a center section of the preforms is extruded. The shape is corrected, if necessary, with deviation from the cylinder shape, in such a manner that a uniform melt distribution occurs in the circumference direction of the gap. In this region, the preforms 1 have an essentially uniform wall thickness. This is shown by the section shown in FIG. 3a. When the beginning and end sections of the preforms 1 are extruded, the sleeve is deformed and an essentially oval cross-sectional shape of the sleeve 9 is set. The end-side preform sections, which are widened in the blow mold to produce a barrel bottom or to produce the upper barrel end, accordingly have a thickness distribution as shown in FIG. 3b. The thick-walled sections of the preforms are assigned to the regions offset by 90° relative to the parting plane of the blow mold halves, which are subject to particularly strong stretching in the blow mold. It was now found that slight thickness changes can also occur in the head region and bottom region of a plastic mass, if the melt distribution in the preforms is influenced only using an elastically deformable sleeve 9. By means of additional program-controlled setting movements of the additional element 10, the melt profile of the preforms can be corrected in the beginning and end sections. The correspondingly corrected melt profile is shown in FIG. 3c. By means of the correction, partial thickness differences in the circumference direction can be evened out in the head region and bottom region of the blow-molded barrels. If, for example, too little or too much wall thickness is present in the region between the tap opening 7 and the collar, the wall thickness can also be influenced with the additional element 10, in the case of an appropriate design.

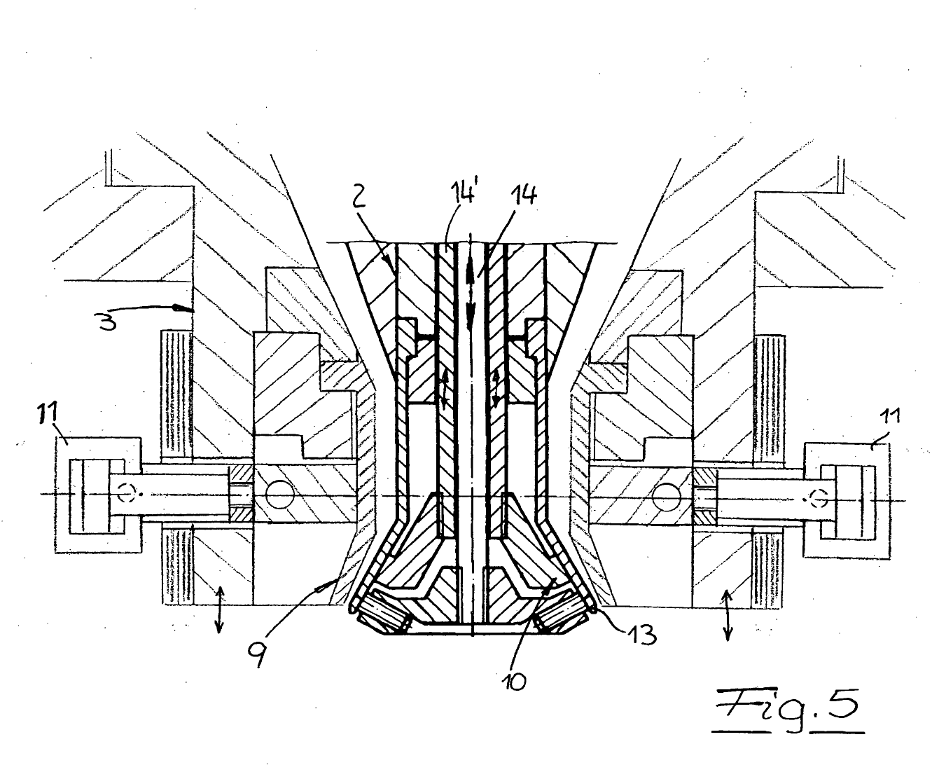

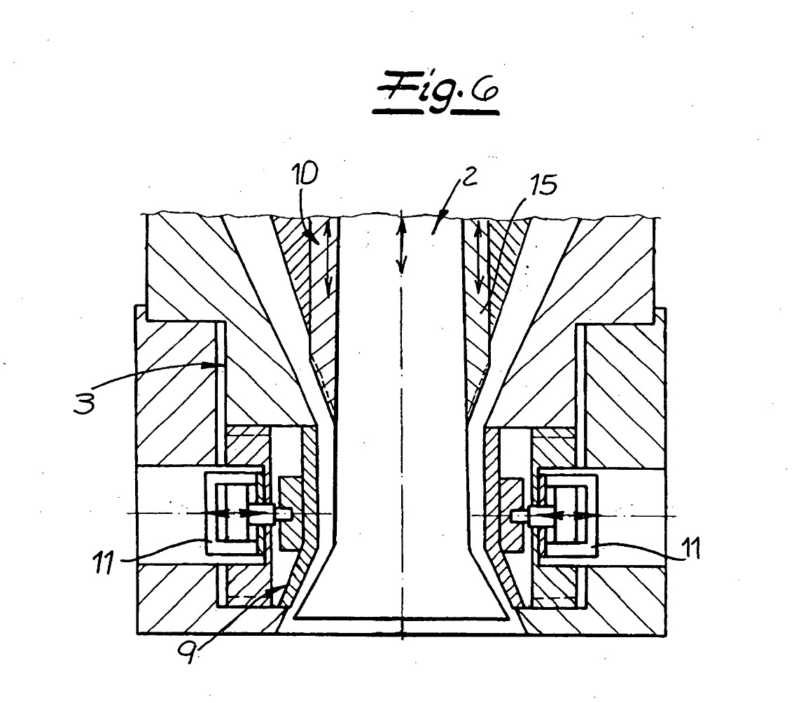

From the figures, it is evident that the elastically deformable sleeve 9 is deformed by means of two force drives 11 that lie opposite one another, the setting movements of which exert tensile and/or pressure forces on the sleeve 9 in a deformation axis oriented radially relative to the center axis of the mandrel. The sleeve 9 is supported in the die housing so as to be radially movable (FIG. 6). If the sleeve 9 is disposed in the flow channel on the mandrel side, the deformation preferably takes place with only one setting drive 14′, which acts on the sleeve 9 by means of radial arms, whereby the arms are preferably connected with the sleeve in articulated manner. The additional element 10 acts at least on sections of the die gap to which deformation-neutral regions of the elastically deformable sleeve are assigned. Deformation-neutral regions are those regions that are only slightly deformable under the effect of the force drives 11. An additional elastically deformable sleeve 13 can be used as the additional element 10, which sleeve also delimits the die gap on the circumference side and is deformed during the extrusion of beginning and end sections of the preforms, by means of activation of at least one setting drive 14, 14′ that acts on the sleeve. In the exemplary embodiment of FIG. 5, two setting drives 14, 14′ that are axially adjustable, in the form of a rod 14 and a cylinder 14′, are provided, which act on the mandrel-side sleeve 13 of the additional element (FIG. 5). The deformation direction of these setting drives 14, 14′ is offset at an angle relative to the deformation axis of the force drives 11 that act on the first sleeve 9. It is understood that a group of two or more elastically deformable sleeves can also be used as the additional element 10.

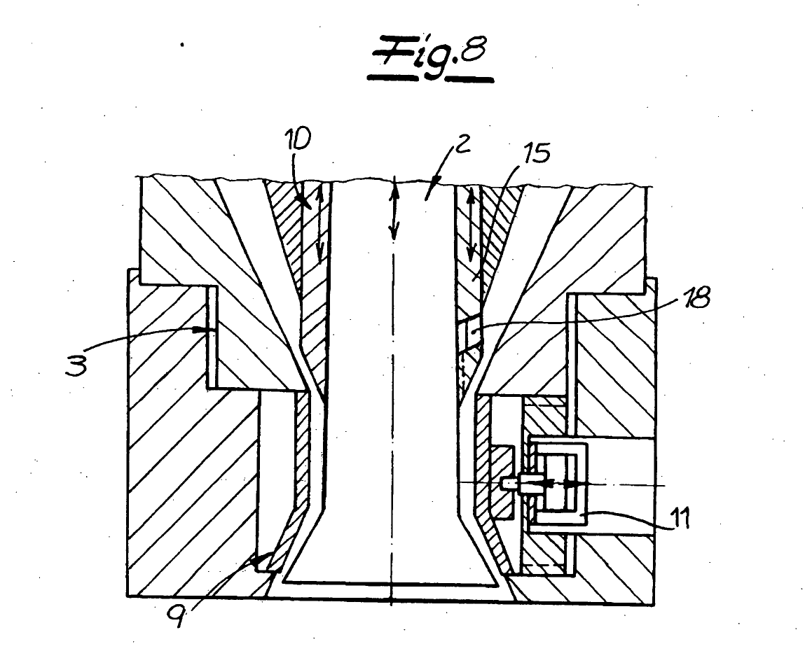

In place of an elastically deformable sleeve, slide valves 15 that are horizontally or vertically adjustable can also be used as the additional element 10; their setting movement partially changes the gap width of the die gap in the circumference direction. Such an embodiment is shown schematically in FIG. 6. The slide valve 15 is configured as a profiled sleeve, and changes the gap width of the flow channel as a function of the slide position. Also, die slide valves, as well as slide valves that act on the flow channel above the die, i.e. in the extrusion head, can be used as the additional element 10. The slide valves can comprise by-pas channels 18 shown in FIG. 8 which control the distribution of the melt flow and the periphery of the slide valve. The slide valves comprising by-pass channels can be arranged at any position of the flow channel between a position inside the extrusion head and the die gap on the inside or on the outside of the flow channel.

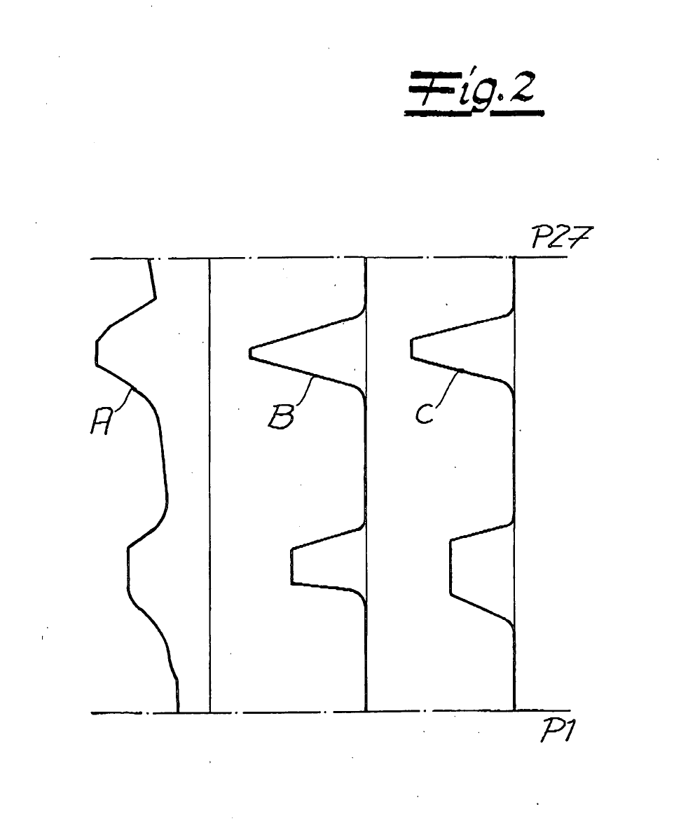

FIG. 2 shows the program control for the setting movement A of the mandrel 2 and/or of the die ring 3, the setting movement B of the force drives 11 that act on the deformable sleeve 9, as well as the setting movement C of the additional element 10 during the extrusion of a tubular preform. The preform is supposed to have such a melt distribution, both in the longitudinal direction and in the circumference direction, that the barrel that is blow-molded from the preform has a wall thickness that is uniform or in accordance with the default values in the longitudinal direction and the circumference direction, and that the wall thickness corresponds to default values particularly also in the critical region at the head end. The setting movements A, B of the mandrel 2 as well as of the force drives 11 that act on the elastic sleeve 9 are controlled by a wall thickness program. A program that controls the setting movements C of the additional element 10 runs at the same time as the wall thickness program. In the exemplary embodiment of FIG. 2, the maximal values of the program curves B, C occur essentially at the same time. This presupposes that the force drives 11 and the additional element 10 are disposed approximately at the same height. It is understood that the maximal values of the program curves B, C can also be offset from one another, in terms of time, depending on the arrangement of the additional element 10, in other words the setting movements controlled by the program curve C can be activated earlier or later, in comparison with the representation in FIG. 2. Regulation circuits can be assigned to the controls, which assure that the setting movements are carried out by the measure predetermined by the control pulse.

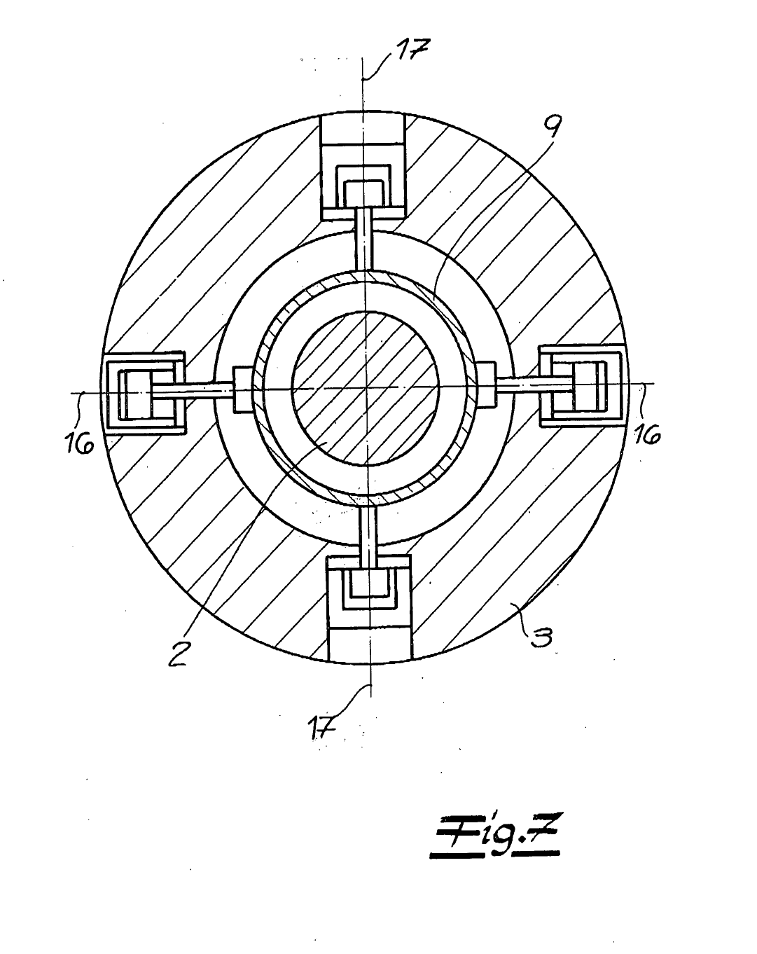

In the exemplary embodiment of FIG. 7, the cross-sectional geometry of an elastically deformable sleeve 9 delimiting the die gap is changed by means of controlled setting movements of first setting devices 16 disposed diametrically opposite one another, during the extrusion of the preforms. Force drives 11 are used as the first setting device 16; they are connected with the sleeve 9 in fixed manner, in terms of tension and pressure. The cross-sectional geometry of the sleeve 9 is changed by means of setting movements of a group of second setting devices 17, which are controlled separately, and are disposed radially offset from the first setting devices 16, and also act on the elastic sleeve 9, in order to correct the melt distribution in the end-side sections of the preforms, which are widened in the blow mold to produce an upper barrel end and a bottom. The setting movement of the added second setting devices 17 is coordinated with the setting movement of the force drives 16 in such a manner that the upper end of the barrels widened in the blow mold and the transition region of the barrels, between barrel bottom and barrel wall, in the circumference direction, have no deviations in thickness from default values. Tappets are used as the second setting device 17, which are moved against the elastic sleeve 9 with radial setting movements. The representation in FIG. 7 shows that the force drives, i.e. the group of the first setting devices 16, on the one hand, and the group of the second setting devices 17, on the other hand, are oriented in such a manner that the force effect direction of the first setting device and the force effect direction of the second setting device are oriented at a right angle relative to one another. The program control shown in FIG. 3 is also suitable for operating the extrusion head shown in FIG. 7, in similar form, with the proviso that the setting movements of the second setting devices 17, which are controlled separately, are controlled in accordance with the program curve C, while the setting movements of the first setting devices 16 follow the program curve B.

What is claimed is:

1. Method for the extrusion of tubular preforms that exit from a die gap of an extrusion head delimited by a mandrel and a die ring, and are widened in a blow mold to produce plastic barrels having a round cross-section and a collar which is formed by upsetting,
whereby the die gap width is changed during the extrusion of the preforms, by means of a setting movement of the mandrel and/or of the die ring,
whereby the cross-sectional geometry of an elastically deformable sleeve delimiting the die gap on the circumference side is changed during the extrusion of the preforms,
whereby the circumference-side melt distribution is influenced, at least in the sections of the preforms that are widened in the blow mold to form an upper barrel end and a barrel bottom, by means of setting movements of at least one additional element that is controlled separately, and
whereby the deformation of the sleeve and the setting movements of the additional element are coordinated with one another in such a manner that the upper end of the barrels widened in the blow mold and the transition region of the barrels between barrel bottom and barrel mantle, in the circumference direction, do not have any thickness deviations from default values.

2. Method according to claim 1, wherein the elastic sleeve is brought into an essentially cylindrical shape in accordance with a control program that runs with the preform extrusion, when a center section of the preforms is extruded, and that by means of deformation of the sleeve, an oval cross-sectional shape of the sleeve is set when the beginning and end sections of the preforms are extruded, which are widened in the blow mold to form a barrel bottom and an upper barrel end, and that by means of additional program-controlled setting movements of the additional element, the melt profile of the preforms is corrected in the beginning and end sections, in order to even out partial thickness differences in the circumference direction in the head region and bottom region of the blow-molded barrels.

3. Method according to claim 1, wherein the elastically deformable sleeve is deformed during the preform extrusion by means of two force drives that lie opposite one another, the setting movements of which exert tensile and/or pressure forces on the sleeve in a deformation axis oriented radially relative to the center axis of the mandrel, and that the additional element acts at least on sections of the die gap to which deformation-neutral regions of the elastically deformable sleeve are assigned, which regions are only slightly deformable under the effect of the force drives.

4. Method according to claim 1, wherein the setting movements of the additional element are controlled by a program that runs at the same time as a wall thickness program, which controls the setting movements of the mandrel and/or of the die ring as well as of the force drives that act on the elastic sleeve.

5. Method according to one of claim 1, wherein the setting movements of the additional element are controlled by a program as a function of time, as a function of path, or as a function of the tube length of the preforms exiting from the die gap.

6. Method for the extrusion of tubular preforms that exit from a die gap of an extrusion head delimited by a mandrel and a die ring, and are widened in a blow mold to produce plastic barrels having a round cross-section and a collar which is formed by upsetting,
whereby the gap width is changed during the extrusion of the preforms, by means of a setting movement of the mandrel and/or of the die ring,
whereby the cross-sectional geometry of an elastically deformable sleeve delimiting the die gap on the circumference side is changed by means of controlled setting movements of first setting devices disposed diametrically opposite one another, during the extrusion of the preforms,
whereby the cross-sectional geometry of the sleeve is changed by means of setting movements of a group of setting devices that are controlled separately and disposed radially offset from the first setting devices, and also act on the elastic sleeve, in order to correct the melt distribution in end sections of the preforms, which are widened in the blow mold to form an upper barrel end or to form a bottom, and
whereby the setting movement of the second setting devices that are added is coordinated with the setting movement of the first setting devices in such a manner that the upper barrel end of the barrels widened in the blow mold, and the transition region of the barrels between barrel bottom and barrel mantle, in the circumference direction, do not have any thickness deviations from default values.

7. Method according to claim 6, wherein the group of the first setting devices and the group of the second setting devices are oriented in such a manner that the force effect direction of the first setting devices and the force effect direction of the second setting devices are oriented at a right angle relative to one another.
